(19) United States
(12) Patent Application Publication
(10) Pub. No.: US 2024/0020101 A1
(43) Pub. Date: Jan. 18, 2024

(54) SYSTEM AND METHOD FOR PERFORMING SELF-STABILIZING COMPILATION

(71) Applicant: INDIAN INSTITUTE OF TECHNOLOGY MADRAS (IIT MADRAS), Chennai (IN)

(72) Inventors: Krishna Nandivada, Chennai (IN); Aman Nougrahiya, Chennai (IN)

(21) Appl. No.: 18/033,783

(22) PCT Filed: Nov. 26, 2021
(86) PCT No.: PCT/IN2021/051108

§ 371 Date: Apr. 25, 2023

(30) Foreign Application Priority Data
Dec. 11, 2020 (IN) 202041054066

(51) Int. Cl. G06F 8/41

(52) U.S. Cl. CPC G06F 8/42

(57) ABSTRACT

Disclosed are systems and methods for automatic self-stabilizing compilation of programs. The method includes receiving an input program and generating a plurality of abstractions of the input program using a plurality of analysis operations, by an analysis component (208). Each one of the plurality of abstractions represents a program state. An optimization component (210) performs an optimization operation on one of the plurality of abstractions (316) based on a set of predetermined elementary transformations (408) to modify the program state. A stabilization component (212) performs stabilization of one or more of the plurality of abstractions (316) using the information captured by the set of predetermined elementary transformations in a stabilization mode. The stabilizing includes updating the one or more abstractions (316) to maintain consistency of the abstractions with the program states.

### CROSS-REFERENCES TO RELATED APPLICATION

This application claims priority to Indian patent application number 202041054066, filed on 11 Dec. 2020.

### FIELD OF THE INVENTION

The disclosure generally relates to compiler infrastructures in computer systems and, in particular, to a system and method for performing self-stabilizing compilation.

### DESCRIPTION OF THE RELATED ART

Mainstream compilers perform multitude of optimization passes on a given input program. Optimization may refer to transformation of computer programs to provide advantages like increased execution speed, reduced program size, reduced power consumption, enhanced security, reduced space utilization, and so on. Typically, an optimization may involve multiple alternating phases of inspections and transformations. In the inspection phase, various program-abstractions, such as intermediate representation (IR) of programs, results of program analysis, etc., may be read to discover opportunities of optimizing the program. Subsequently, the program is transformed in the transformation phase by invoking appropriate writers on the intermediate representations of the program, such as abstract syntax tree (AST), three-address codes, etc.

Upon transformation of a program, the program abstractions, such as points-to graph, constant maps, and so on, generated by various analysis may be inconsistent with the modified state of the program. This prevents correct application of the downstream transformations until the relevant abstractions are stabilized, either via incremental update, or via invalidation and complete recalculation. Thus, unless explicit steps are taken to ensure that the program-abstractions always reflect the correct state of the program at the time of being accessed, the correctness of the inspection phase(s) of the downstream optimizations cannot be ensured, which in turn can negatively impact the optimality, and even the correctness of the optimization.

In general, the existing compiler frameworks do not perform automated stabilization of such abstractions. As a result, the optimization writer have the additional burden to identify (i) what data structures associated with program-abstractions to stabilize, (ii) where to stabilize the data structures, and (iii) how to perform the actual stabilization. Further, adding new analysis becomes a challenge as existing optimizations may impact it. Moreover, the challenges become much more difficult in the case of compilers for parallel languages, where transformations done in one part of the code may warrant stabilization of program-abstractions of some seemingly unconnected part, due to concurrency relations between both the parts.

There have been various attempts towards enabling automated stabilization of specific program-abstractions, in response to program transformations in compilers of serial programs. However, these efforts involve different drawbacks. For example, Carle and Pollock [1989], and Reps et al. [1983] require that the program-abstractions have to be expressed as context dependent attributes of the language constructs, which is very restrictive. Carroll and Polychronopoulos [2003] do not handle pass dependencies and compilers of parallel programs. Blume et al. [1995], Brewster and Abdelrahman [2001] handle only a small set of program-abstractions, and hence insufficient.

Further, there are also some publications relating to incremental update of data-flow analysis. Arzt and Bodden [2014] have provided approaches to enable incremental update for IDE-/IFDS-based data-flow analyses. Ryder [1983] discusses two powerful incremental update algorithms for forward and backward data-flow problems, based on Allen/Cocke interval analysis [Allen and Cocke 1976]. Sreedhar et al. [1996] disclose methods to perform incremental update for elimination-based data-flow analyses. Some important approaches have been given by Carroll and Ryder [1987, 1988] for incremental update of data-flow problems based on interval, and elimination-based analyses. Owing to the presence of inter-task edges (or communication edges) in parallel programs, such as OpenMP programs, there are a large number of improper regions (irreducible subgraphs) in the control and data flow representations of such programs, rendering any form of structural data-flow analyses infeasible over the graph [Muchnick 1998]. Other publications include works by Marlowe and Ryder [1989] and from the two-phase incremental update algorithms for iterative versions of data-flow analysis given by Pollock and Soffa [1989]. However, the pass writer needs to provide additional information to ensure incremental update of their data-flow analyses in these publications.

Given the importance of data-flow analyses, there have been numerous publications that have provided analysis-specific methods for incremental update, as well as its parallelism. For instance, in the context of C programs, Yur et al. [1997 ] have provided incremental update mechanisms for side-effect analysis. Chen et al. [2015] have provided incremental update of inclusion-based points-to analysis for Java programs. Similarly, Liu et al. [2019] have provided an incremental and parallel version of pointer analysis. However, these and other publications are not generic in nature. Therefore, there are no compiler designs or implementations that address the challenges discussed above and guarantee generic self-stabilization, especially in the context of parallel programs. In contrast, the disclosed method completely hides the implementation of parallelism semantics, and incremental modes of self-stabilization, from the writers of existing and future iterative data-flow analyses (IDFAs).

### SUMMARY OF THE INVENTION

A computer-implemented method for automatic self-stabilizing compilation of programs is disclosed. The method includes receiving an input program. A plurality of abstractions of the input program are generated using a plurality of analysis operations, wherein each one of the plurality of abstractions represents information associated with a program state at compile time. Next, the method includes performing one or more optimization operations on one of the plurality of abstractions expressed in terms of one or more predetermined elementary transformations. The predetermined elementary transformations capture the information associated with the modified program state. One or more of the plurality of abstractions are stabilized by a stabilizer using the information captured by the set of predetermined elementary transformations in a stabilization mode. The stabilizing includes updating the one or more abstractions using the captured information to maintain consistency of the abstractions with the modified program states.

In various embodiments, the predetermined elementary transformations include adding, deleting, or modifying syntactic parts of the program. In some embodiments, the stabilization mode is one of a lazy-invalidate stabilization mode, lazy-update stabilization mode, eager-update stabilization mode, eager-invalidate stabilization mode, or any combination thereof. In various embodiments, the one or more abstractions represent information associated with a serial or parallel program. In some embodiments, the plurality of abstractions include intermediate representation, a control flow graph, and an abstract syntax tree. In some embodiments, the plurality of abstraction includes iterative data flow analyses, and wherein the iterative data flow analyses are stabilized using automatic lazy-update stabilization mode. In some embodiments, the method includes stabilizing the one or more abstractions in response to performing new optimization operation, wherein the stabilizing comprises updating the one or more abstractions to maintain consistency of the abstractions with the modified program states.

According to another embodiment, a system for performing automatic self-stabilizing compilation of programs is disclosed. The system includes an analysis component configured to receive an input program and perform a plurality of analysis operations of the input program to generate a plurality of abstractions, wherein each one of the plurality of abstractions represents information associated with a program state at compile time. The system includes an optimization component configured to perform one or more optimization operations on one of the plurality of abstractions by modifying the program state associated with the abstraction based on a set of predetermined elementary transformations, which capture the information associated with the modified program state. The system also includes a stabilizer configured to stabilize one or more of the plurality of abstractions using the information captured by the set of predetermined elementary transformations, wherein the stabilizing includes updating the one or more abstractions using the captured information to maintain consistency of the abstractions with the modified program states.

In various embodiments, the analysis component includes pre-processing unit, lexical analysis unit, syntax analysis unit, and semantic analysis unit. In some embodiments, the stabilizer is configured to operate in a stabilization mode, wherein the stabilization mode is one of lazy-invalidate stabilization mode, lazy-update stabilization mode, eager-update stabilization mode, eager-invalidate stabilization mode, or any combination thereof. In some embodiments, the optimization component includes one or more abstraction readers and one or more abstraction writers. The one or more abstraction readers are configured to read the one or more abstractions and the one or more abstraction writers are configured to modify the one or more abstractions.

This and other aspects are described herein.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1 illustrates a flow diagram for a method for automatic self-stabilizing compilation of programs, according to one embodiment of the present subject matter.

FIG. 2 illustrates a block diagram of a system for performing automatic self-stabilizing compilation of programs, according to one embodiment of the present subject matter.

FIG. 3 illustrates a block diagram of compilation process, according to one embodiment of the present subject matter.

FIG. 4 illustrates a block diagram of the optimization process, according to one embodiment of the present subject matter.

FIG. 5 illustrates a flow diagram of an alternating inspection phase and transformation phase of each code optimization process, according to one embodiment of the present subject matter.

FIG. 6 illustrates a flow diagram of the steps performed during an abstraction getter invoked by the inspection phase, according to one embodiment of the present subject matter.

FIG. 7 illustrates a flow diagram of the steps performed during an elementary transformation invoked by the transformation phase, according to one embodiment of the present subject matter.

FIG. 8 illustrates a flow diagram of the steps performed by the stabilizer of abstraction, according to one embodiment of the present subject matter.

FIG. 9 illustrates a flow diagram for a phase stabilizer handling impact of a node addition on phase information, according to one embodiment of the present subject matter.

FIG. 10 illustrates a flow diagram for a phase stabilizer handling impact of a node removal on phase information, according to one embodiment of the present subject matter.

FIG. 11 illustrates a flow diagram of the IDFA stabilization, according to one embodiment of the present subject matter.

FIG. 12A-12B illustrate a flow diagram of the first pass of IDFA stabilizer, according to one embodiment of the present subject matter.

FIG. 13 illustrates a flow diagram of the second pass of IDFA stabilizer, according to one embodiment of the present subject matter.

FIG. 14 illustrates client optimization pass for removal of barriers for parallel programs, according to one embodiment of the present subject matter.

FIG. 15 illustrates a chart depicting speedup in IDFA stabilization-time under various modes of stabilization, according to one example of the present subject matter.

FIG. 16 illustrates a chart depicting savings in memory footprint (maximum resident set size) under various modes of self-stabilization, according to one example of the present subject matter.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The present subject matter describes methods and systems for self-stabilizing compilation of computer programs for serial and parallel programming applications. According to the present subject matter, self-stabilizing compilation relates to updating of the internal program-analyses-related information within a compiler, in response to program changes due to different optimizations within the compiler.

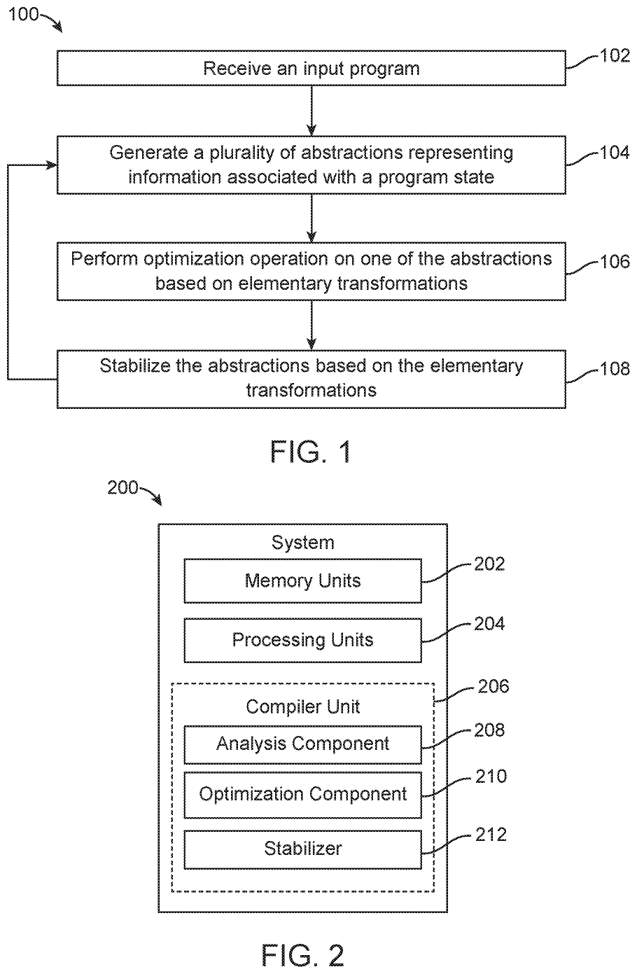

A flow diagram for a method for automatic self-stabilizing compilation of programs is illustrated in FIG. 1, according to various embodiments of the present subject matter. The method 100 may include receiving an input program at block 102. A plurality of abstractions of the input program may be generated using a plurality of analysis operations at block 104. Each one of the plurality of abstractions may represent some information associated with a current program state. In some embodiments, the plurality of abstractions may include intermediate representation, a control flow graph, an abstract syntax tree, a concrete syntax tree, and the like.

Next, a series of optimization operations may be performed on one of the plurality of abstractions by modifying the program state associated with the abstraction based on a set of predetermined elementary transformations at block 106. The optimization operation may be performed using the information present in one or more of the plurality of abstractions. In various embodiments, the optimization operation may include inspection and transformation of the abstractions. Each transformation may involve modification of the program or abstraction state. In various embodiments, the predetermined elementary transformations may include adding, deleting, or modifying syntactic parts of the input program.

One or more of the plurality of abstractions may be stabilized using the information captured by the set of predetermined elementary transformations in a stabilization mode at block 108. The stabilizing may include updating the one or more abstractions to maintain consistency of the abstractions with the modified program states. In various embodiments, the steps 104, 106, and 108 may be performed multiple times during the compilation of the received input program. In some embodiments, the stabilization mode is one of a lazy-invalidate stabilization mode, eager-update stabilization mode, eager-invalidate stabilization mode, and an lazy-update stabilization mode. In various embodiments, the method may include stabilizing one or more abstractions of parallel programs. In various embodiments, the method may further include automatically stabilizing the one or more abstractions in response to adding new optimization by updating the one or more abstractions to maintain consistency of the abstractions with the modified program states.

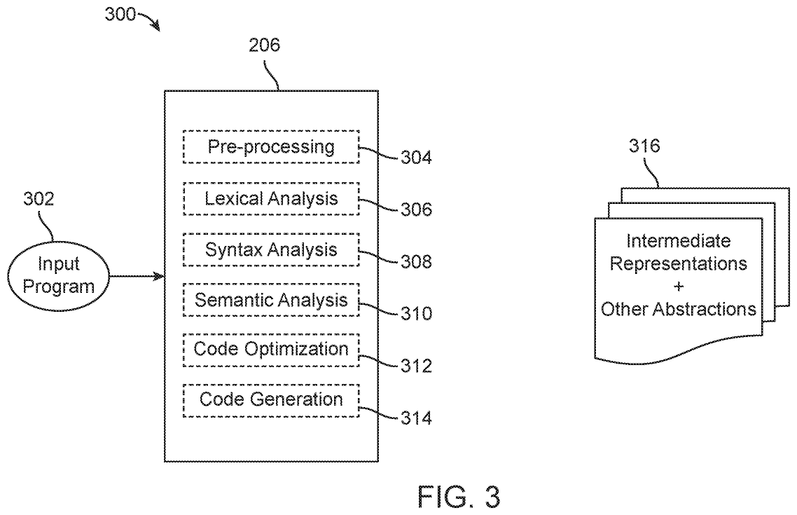

A block diagram of a system 200 for performing automatic self-stabilizing compilation of programs is illustrated in FIG. 2, according to various embodiments of the present subject matter. The system 200 may primarily include memory units 202, processing units 204, and a compiler unit 206. The compiler unit 206 may include an analysis component 208 configured to receive an input program and perform a plurality of analysis operations of the input program to generate a plurality of abstractions. Each abstraction represents information associated with a program state at compile time. The compiler unit 206 may also include an optimization component 210 configured to perform one or more optimization operations on one of the plurality of abstractions by modifying the program state associated with the abstraction based on a set of predetermined elementary transformations to modify the program state. The set of predetermined elementary transformations capture the information associated with the modified program state. Further, the compiler unit may also include a stabilizer 212 configured to stabilize one or more of the plurality of abstractions using the information captured by the set of predetermined elementary transformations by updating the one or more abstractions to maintain consistency of the abstractions with the modified program states. In various embodiments, the stabilizer 212 may be configured to operate in a stabilization mode, which may be one of lazy-invalidate stabilization mode, lazy-update stabilization mode, eager-update stabilization mode, eager-invalidate stabilization mode, and any combination thereof.

A block diagram of the compilation process is illustrated in FIG. 3. The compilation process 300 may include alternating phases of analysis and optimization of the input program 302. In various embodiments, the input program 302 may be a parallel program, or alternatively be a serial program. As discussed earlier, the compiler unit 206 may include an analysis component 208 and an optimization component 210. In various embodiments, the analysis component 208 and the optimization component 210 may be part of either a front-end or back-end of the compiler or both. In some embodiments, the analysis component 208 may include a pre-processing unit 304, lexical analysis unit 306, syntax analysis unit 308, and semantic analysis unit 310. The optimization component 210 may include the code optimization 312 and the code generation 314. The units 304 to 314 may read and write to one or more abstractions 316.

The pre-processing unit 304 may be configured to expand various macros and header files in the input program. The lexical analysis unit 306 may be configured to break the source code text into a sequence of small pieces called lexical tokens, such as keywords, operators, literals, identifiers, and the like. The syntax analysis unit 308 may also be configured to identify syntactic structure in the input program by parsing the token sequence. In some embodiments, the syntax analysis may generate an abstraction 316 such as a parse tree, which represents the program in a tree structure.

The semantic analysis unit 310 may be configured to generate a new abstraction or modify the existing abstractions 316 by performing operations like type checking, object binding, rejecting incorrect programs or issuing warnings. The code optimization unit 312 may be configured to perform machine dependent and machine independent optimizations of the program. The transformed program may be translated by the code generation unit 314 into an output language, such as assembly language, bytecode, or machine code.

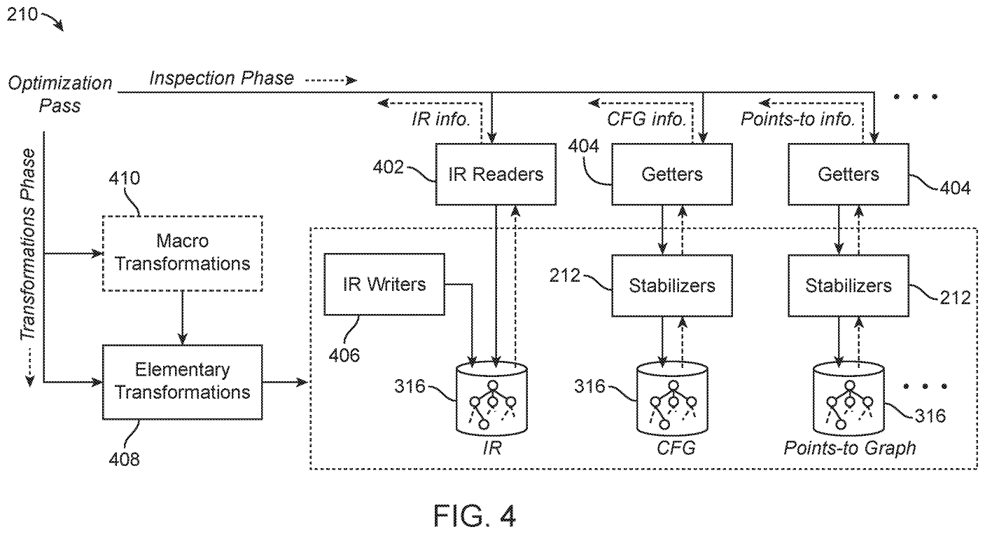

A block diagram of the self-stabilization compilation is illustrated in FIG. 4, according to another embodiment of the present subject matter. Each optimization pass may include alternating phases of inspection and transformation of program abstractions. In the inspection phase, various program-abstractions, such as intermediate program representation and results of program analysis, may be read to identify opportunities of improvements in the program. In various embodiments, the program abstractions 316 may be points-to graph, control-flow graph, three-address codes, and the like.

Abstraction readers 402 (or intermediate representation readers) may be configured to read the one or more abstractions 316 into the memory, such as hard disk or the random access memory (not shown in figure). Abstraction getters 404 may be configured to query internal state of the underlying abstractions 316. Abstraction writers 406 (or intermediate representation writers) may be configured to perform transformations on the one or more abstractions or intermediate representations 316. The transformation may be performed based on a plurality of predetermined elementary transformations 408 and macro transformations 410. In various embodiments, the plurality of predetermined elementary transformations 408 may include one or more basic operations, such as addition, removal, or modification of the abstraction. Each transformation may be internally expressed as a sequence of one or more elementary transformations. For instance, an elementary transformation may include addition or removal of nodes or control-flow edges in an abstraction, such as a control flow graph abstraction. The transformation of the abstraction may involve modification of the state of the program.

The one or more elementary transformations 408 may be communicated to one or more stabilizers 212 of each abstraction 316. In various embodiments, each abstraction 316 may be associated with a stabilizer 212. The one or more stabilizers 212 may be configured to stabilize the one or more abstractions using the information captured by the elementary transformation used earlier. In various embodiments, a default universal stabilizer may be used as a base class of all program abstractions that stabilizes any program-abstraction using the fixed set of abstraction-specific fundamental operations.

In various embodiments, the abstraction writer 406 may be invoked only via the elementary transformations. The abstraction getters 404 of each program abstraction 316 may access the internal state of the corresponding abstraction only via a set of dedicated stabilizers 212, which ensure that every observable state of the abstraction is consistent with the current state of the intermediate representation of the program.

In various embodiments, each concrete program abstraction class may inherit from the abstract base class of program-abstractions (BasePA). The base class may include one or more common methods and data-structures necessary for self-stabilization. The stabilization process may be triggered by abstraction getters of each valid program-abstraction in response to a transformation. In various embodiments, a global set (allAbstractions) of the program abstractions may be maintained, and in the constructor of base class of program-abstractions (BasePA), which may be invoked implicitly during construction of every program-abstraction object A, a reference of A may be added to allAbstractions.

In the constructors of the base abstraction, one or more data structures local to the abstractions may be initialized. The one or more data structures may store information of edges added, edges removed, nodes added, and nodes removed during elementary transformations. The data structures may be needed for self-stabilization of the abstraction. An example of the constructor of BasePA may be given as:

```
public BasePA::BasePA( ) {/* Constructor of the base abstraction class . */
  Global .allAbstractions. add( this );
  addedEdges=new . . . ; removedEdges=new . . . ; addedNodes= new . . . ;
    removedNodes=new . . . ;}
```

In various embodiments, the stabilization of program-abstractions in response to the modifications performed by an optimization operation may be done by directly modifying the internal representations of the program-abstraction. Alternatively, and more preferably, the program-abstraction may perform the stabilization internally, i.e., the program-abstraction may be informed of the exact modifications which have been performed on the program.

In various embodiments, the predetermined elementary transformations may be used as the missing link between optimizations and program-abstractions. The predetermined elementary transformations may capture all the program modifications via the one or more fundamental operations. In each elementary transformation, the information about addition/deletion of nodes, control-flow edges, call-edges, and inter-task edges may be collected. The collected information may be sent to every program-abstraction object, present in the set allAbstractions.

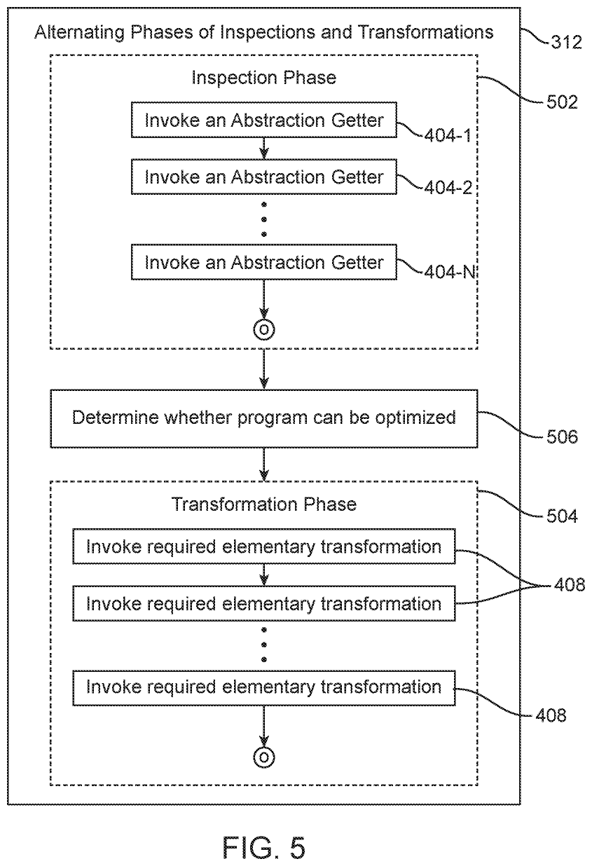

A flow diagram for an alternating inspection phase and transformation phase of the code optimization process is illustrated in FIG. 5, according to various embodiments of the present subject matter. As discussed, the code optimization process 312 may include alternating phases of an inspection phase 502 and a transformation phase 504. In the inspection phase, one or more abstraction getters 404-1, 2, . . . N may be invoked. The method may involve using the inspected abstractions to determine whether the program may benefit from optimization, at block 506. If optimization is performed, then one or more elementary transformations 408 may be invoked in the transformation phase 504.

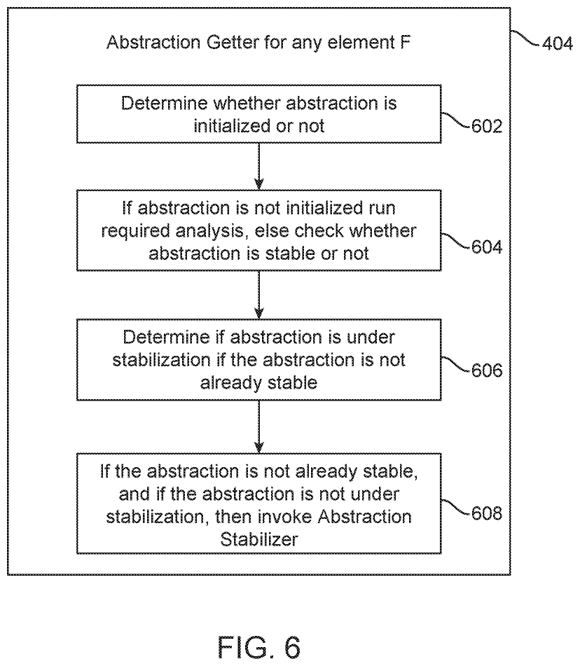

A flow diagram of the steps performed during the inspection phase 502 by the abstraction getters 404 is illustrated in FIG. 6, according to one embodiment of the present subject matter. The abstraction getters 404, for an element F from the domain of the abstraction, may check whether the associated abstraction is initialized or not at block 602. If the abstraction is not initialized, then the required analysis operation may be performed, and subsequently the value of element F may be returned. The analysis initialization operations may be performed by the analysis component 208 as described earlier. Alternatively, if the abstraction getter 404 determines that the abstraction is initialized, then the abstraction getters 404 may determine whether the abstraction is stable or not, at block 604. The current value of F may also be returned without further computation, if the abstraction is determined to be already stable. If the abstraction is already initialized and the abstraction is not stable, then the abstraction getter 404 may check whether the abstraction is under stabilization or not at block 606. If the abstraction is undergoing stabilization, then a conservative value of element F may be returned. In various embodiments, the abstraction getters 404 may be configured to ignore values of unstable abstractions. If the stabilization is not started, the abstraction getter 404 may invoke the abstraction stabilizer 212 at block 608 to perform stabilization and then value of F is returned.

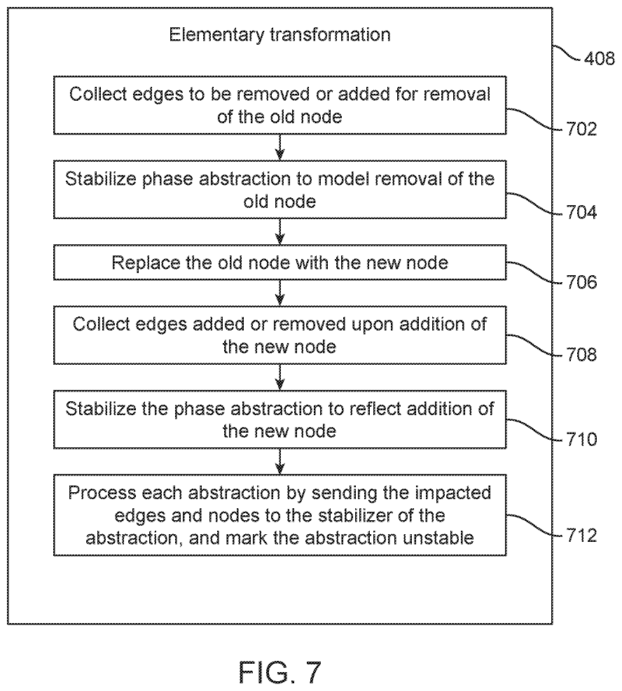

A flow diagram of the steps performed during the transformation phase by the elementary transformation process is illustrated in FIG. 7, according to one embodiment of the present subject matter. As shown, the steps performed in elementary transformation 408 may include collecting edges to be removed or added for removal of the old node in an abstraction at block 702. A phase abstraction may be stabilized to model removal of the old node at block 704. Next, the old node may be replaced with a new node at block 706. The method also involves collecting edges added or removed upon addition of the new node at block 708. The phase abstraction may be stabilized to reflect addition of the new node at block 710. Each abstraction may be processed by sending the impacted edges and nodes to the stabilizer of the abstraction, which may be marked as unstable, at block 712.

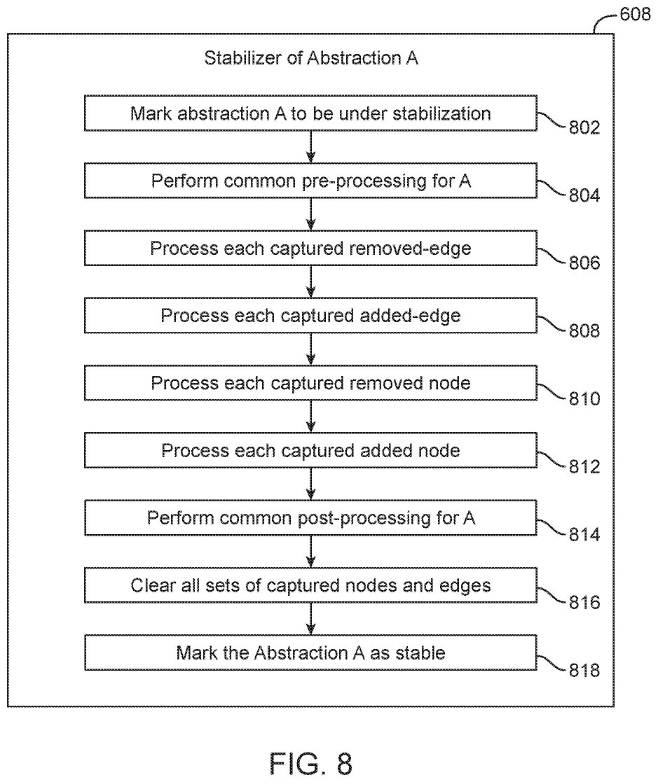

A flow diagram of the steps performed by the stabilizer of abstraction A is illustrated in FIG. 8 according to one embodiment of the present subject matter. To stabilize any program-abstraction, the stabilizer 212 may be invoked to perform a sequence of steps. When stabilization is requested, the stabilizer 212 may oversee the self-stabilization process on the basis of abstraction-specific methods and internal sets, which store information about edges added, edges removed, nodes added, and nodes removed. In various embodiments, the stabilizer 212 may process the impact of edge removal operations, edge addition operations, node removal operations, and node addition operations, on an abstraction. The stabilizer 212 may also optionally perform common pre-preprocessing and common post-processing operations.

As illustrated in FIG. 6, the abstraction stabilizer 212 may be invoked if the abstraction is not yet stabilized at 608. The invoked abstraction stabilizer 212 may mark abstraction A as to be under stabilization at block 802. The stabilizer 212 may perform common pre-processing for the abstraction A at block 804. Each captured removed-edge and captured added-edge may be processed at block 806 and 808. Each captured removed node and added node may be processed at block 810 and 812, respectively. In various embodiments, the steps at 806-812 may be performed in any order. Next, a common post processing may be performed for abstraction A at block 814. In various embodiments, the common pre-processing and post-processing steps may be optionally used for specifying program-abstraction specific initialization and cleanup tasks that may be required for stabilization. The base class BasePA may provide a default (empty) implementation of the pre-processing and post-processing steps. All sets of captured nodes and edges may be cleared at block 816 and the abstraction A may be marked as stable at block 818.

In various embodiments, the plurality of abstractions 316 may include phase analysis (or concurrency analysis). In phase analysis if a node n that has been added to the program does not internally contain any global synchronization operation among threads, such as a barrier, then the phase information of the CFG neighbors of n may be reused to stabilize the phase information of n and its children. The node removal may also be done similarly. When the node being added or removed may contain a barrier, it may change the phase information (globally). Thus, the phase information may be re-computed from the beginning (by calling its initialization operations from analysis component 208). Note that if the phase stabilization leads to addition/removal of any inter-task edges, those edges may be captured in addedEdges/removedEdges sets.

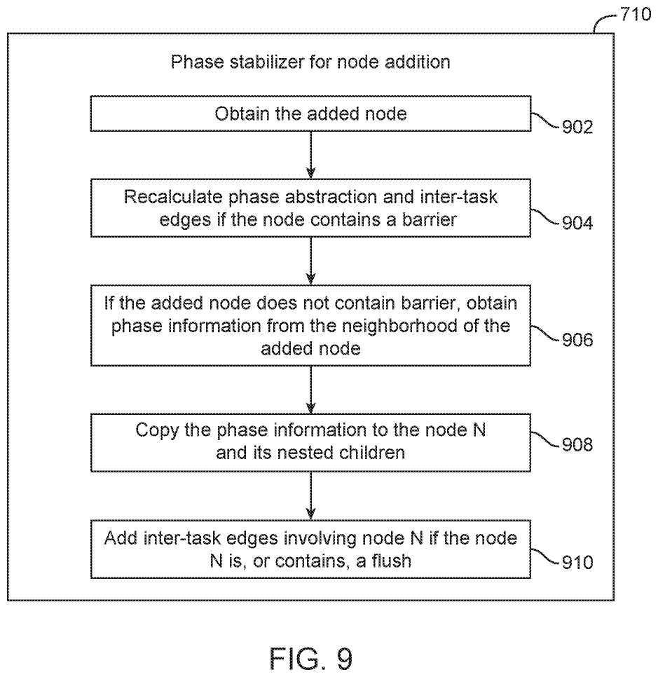

A flow diagram for handling the impact of node addition on phase information by the phase stabilizer is illustrated in FIG. 9, according to one embodiment of the present subject matter. The phase stabilizer may obtain the added node at block 902. The phase stabilizer may check whether the node contains a barrier. If the node contains a barrier, the phase stabilizer may recalculate phase abstraction and inter-task edges at block 904. If the node does not contain a barrier, then the phase information may be obtained from the neighborhood of the added node at block 906. The phase information may be copied to the node N and its nested nodes at block 908. If the node N is, or contains, a flush, then inter-task edges may be added to the involving node N at block 910.

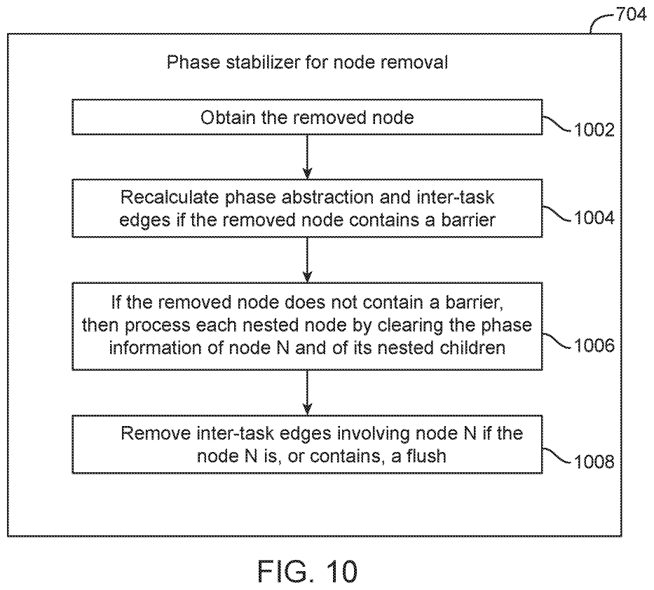

Similarly, a flow diagram for handling the impact of node removal on phase information by the phase stabilizer is illustrated in FIG. 10, according to one embodiment of the present subject matter. The method may include obtaining the removed node at block 1002. If the node contains a barrier, then the phase stabilizer may recalculate phase abstraction and inter-task edges at block 1004. If the node does not contain a barrier, then the phase stabilizer may process each nested node by clearing the phase information of node N at block 1006. The phase stabilizer may remove inter-task edges involving node N if the node N is, or contains, a flush at block 1008.

In various embodiments, the program abstractions 316 may include results for iterative data flow analysis (IDFA). The disclosed method provides a generic template that may be used to instantiate any IDFA (for example, points-to analysis) without any additional code to realize self-stabilization. In order to realize self-stabilization an internal set (seeds) of nodes, starting which the flow maps may need an update as a result of program transformations, may be maintained. The seeds set is populated in the methods (node removal/addition and edge removal/addition) with those nodes whose IN (or OUT) flow maps need to be recalculated due to the changes to their predecessors (or successors), in case of forward (or backward) analyses. The default (empty) implementation of common preprocessing may not be required to be overridden and common post-processing may be overridden to invoke self-stabilization procedure that takes seeds as argument.

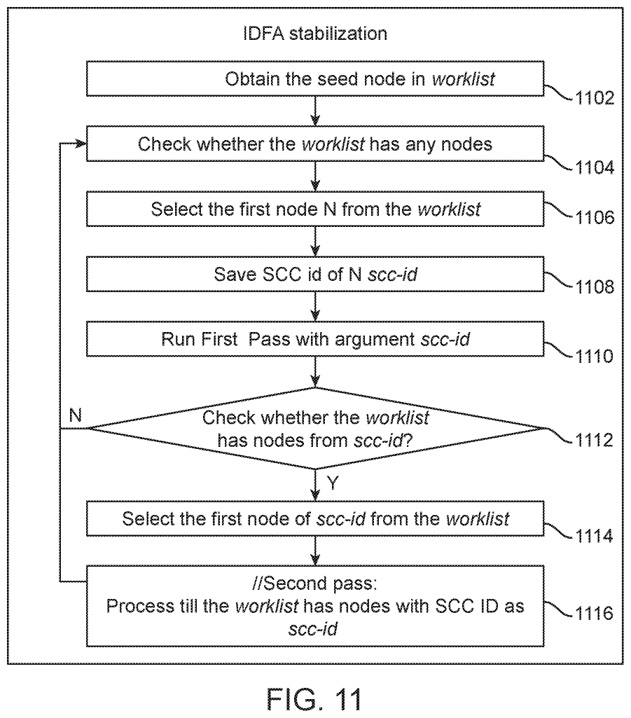

A flow diagram of the IDFA stabilizer is illustrated in FIG. 11, according to one embodiment of the present subject matter. The method may include obtaining the seed nodes in worklist at block 1102. The method may check whether the worklist is empty at block 1104. If the worklist is not empty at block 1104, then the first node from the worklist may be selected at block 1106. The SCC id of the node may be saved at block 1108. A first pass with argument scc-id may be run at block 1110. Next, the method may involve checking whether the worklist has nodes from scc-id at block 1112. If the worklist has nodes from the scc-id at block 1112 then the first node of scc-id may be selected from the worklist at block 1114. A second pass with the argument scc-id may be run at block 1116.

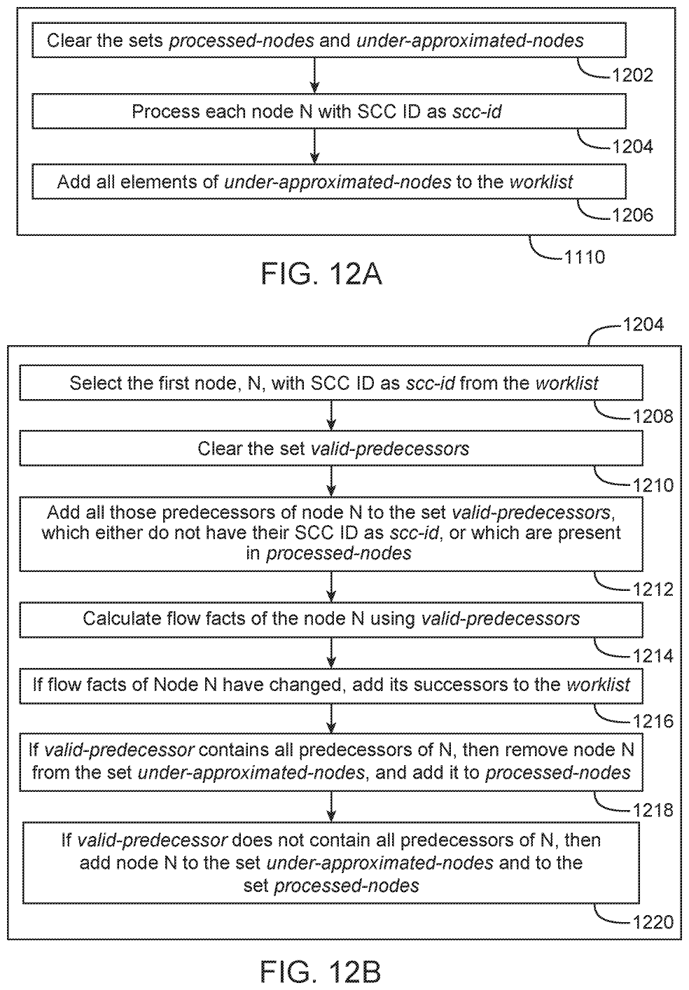

A flow diagram of the first pass of IDFA stabilizer in block 1110 is illustrated in FIG. 12A-12B, according to an embodiment of the present subject matter. The sets processed-nodes and under-approximated-nodes may be cleared at block 1202. Each node N having SCC ID as scc-id may be processed at block 1204, then all elements in under-approximated-nodes may be added to the worklist at block 1206. The processing at block 1204 may involve selecting the first node N with SCC ID as scc-id from the worklist, if the worklist has the nodes with SCC ID as scc-id at block 1208. The set valid-predecessors may be cleared at block 1210. All predecessors of N whose SCC ID is not scc-id, or which are present in processed-nodes, may be added to the set valid-predecessors at block 1212. The flow facts of the node N may be calculated using valid-predecessors at block 1214. If the flow facts of node N change, then its successors may be added to the worklist at block 1216. If the set valid-predecessors contains all predecessor of N, then the node N may be removed from the set under-approximated-nodes at block 1218, and added to the set processed-nodes. If the set valid-predecessors does not contain all predecessors of N, then node N may be added to the set under-approximated-nodes as well as to the set processed-nodes at block 1220.

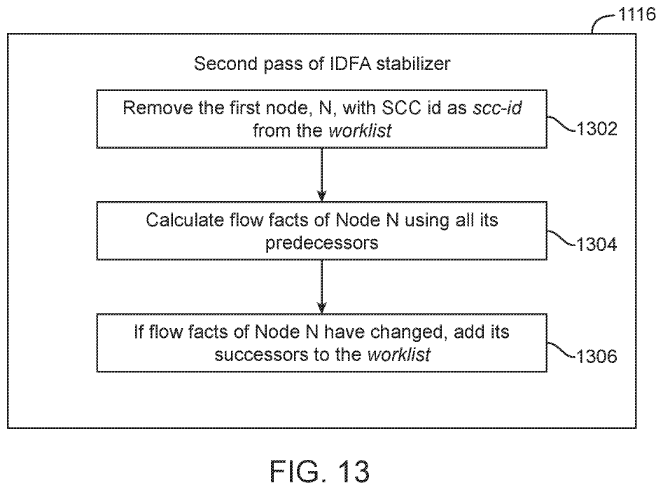

A flow diagram of the second pass of IDFA stabilizer, for each node in the worklist with SCC id as scc-id, is illustrated in FIG. 13, according to one embodiment of the present subject matter. The method may involve removing the first node N with SCC id as scc-id from the worklist at block 1302. The flow facts of node N may be calculated using all its predecessors at block 1304. If the flow facts of node N have changed then its successors may be added to the worklist at block 1306.

### EXAMPLES

### Example 1: Stabilization Modes Assessment

The time and manner in which a program abstraction is stabilized under program modifications is important and the two choices for performing stabilization may be eager versus lazy and invalidate versus update.

On the basis of these two dimensions, the following four modes of stabilization for any program abstraction were assessed: (i) Eager-Invalidate (EGINV), (ii) Eager-Update (EGUPD), and (iii) Lazy-Invalidate (LZINV), (iv) Lazy-Update (LZUPD). The four modes of stabilization were then compared.

Eager versus lazy: In case of eager mode, for each program-abstraction (say A), an optimization involving k elementary transformations would lead to k invocations of its stabilizer (say, I₁, I₂, . . . , Iₖ). There may be many instances where A is not read between the invocations Iᵢ . . . Iⱼ (1≤i<j≤k). In such cases the invocations Iᵢ, Iᵢ₊₁, . . . Iⱼ₋₁ of the stabilizer are redundant. In contrast, lazy-stabilization avoids such redundancies.

Invalidate versus update: Though the update modes seem much more efficient than the invalidate modes, in practice the difference in their performance depends on a number of factors, such as the number of program modifications, the complexity of the associated incremental update, and so on. Further, designing the update modes for certain program-abstractions is quite a challenging task. To address such issues, the self-stabilization compiler may support both invalidate, as well as update modes of (lazy) stabilization.

Note that while, in general, LZUPD seems to be the most efficient mode of stabilization in terms of performance, EGINV mode of stabilization is closest to the custom code that is generally written by the compiler writer in case of conventional compilers, especially in the absence of any notion of incremental update of relevant program-abstractions.

### Example 2: Optimization Pass: Barrier Remover for OpenMP Programs

The self-stabilizing method was used by a compiler writer to efficiently design or implement new optimizations without having to write any extra code for stabilization of program-abstractions. To illustrate the benefits of using the disclosed compilation method, an involved optimization pass that reduces redundant barriers in OpenMP C programs was used.

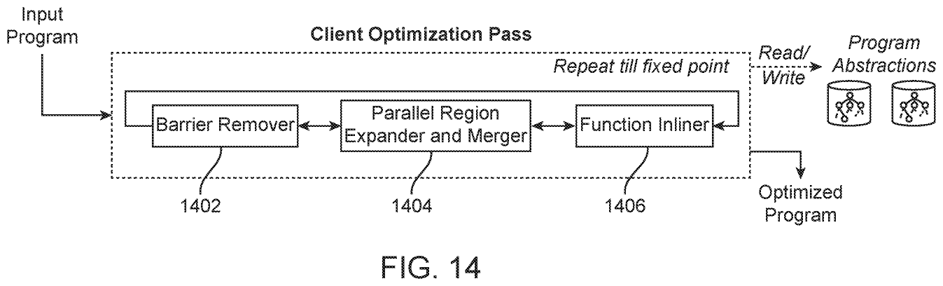

The barrier remover method performs the following steps, as shown in the block diagram in FIG. 14. The method includes removing redundant barriers (within a parallel region) at block 1402. The removal does not violate any data dependence between the statements across them. The remaining two steps help improve the opportunities for barrier remover within each function. The parallel regions are expanded and merged at block 1404, while possibly expanding their scope to the call-sites of their enclosing functions, wherever possible. This helps in bringing more barriers (including the implicit ones) within the resulting parallel region, thereby creating new opportunities for barrier remover. Next, the method includes inlining the monomorphic calls whose target function is (i) not recursive, and (ii) contains at least one barrier, at block 1406. The three steps are repeated till fixed-point (no change). The three steps involve many interleaved phases of inspection and transformation, which in turn lead to a number of interleaved accesses (reads and writes) to various program-abstractions, such as phase information, points-to information, super-graph (involving CFGs, call-graphs, and inter-task edges), AST, and so on.

In contrast to the case of designing or implementing the method in the context of a traditional compiler, implementing the method in the context of self-stabilizing compilation requires only the implementation of the three optimization steps described above, and needs no explicit code for stabilization of the relevant program-abstractions. Furthermore, the optimization writer does not even have to specify what program-abstractions are needed to be stabilized. Therefore, the optimization writer remains oblivious to the questions like which abstraction need to be stabilized, where to invoke stabilization code, and how to stabilize each of the abstractions even in the context of an involved optimization.

### Example 3A: Performance Evaluation in Terms of Compilation Time

The performance evaluations of the lazy modes of stabilization were conducted by studying the parameters related to compilation time in the context of the optimization discussed in Example 2.

An evaluation describing the impact of the lazy modes of self-stabilization on the compilation time of the above discussed benchmark programs while running barrier remover method is disclosed. For reference, in Table 1, columns 7-10 show the time spent (in seconds) in self-stabilization and the total compilation time, in the context of the EGINV and LZUPD modes of self-stabilization, while performing barrier remover. As discussed earlier, EGINV is arguably the simplest (and natural) way to achieve self-stabilization.

TABLE 1
Benchmark Characteristics

| | | 2 | 3 | 4 | 5 | 6 | 7 | 8 | 9 | 10 | 11 | 12 |
|---|---|---|---|---|---|---|---|---|---|---|---|---|
| Sl. | 1 | Characteristics | | | | | STB-time | | Total time | | Memory | |
| No. | Benchmark | #LOC | #Leaf | #PC | #Barr | #Ph | EGINV | LZUPD | EGINV | LZUPD | EGINV | LZUPD |
| 1 | BT (NPB) | 3909 | 4450 | 9 | 47 | 558 | 26.29 | 1.27 | 40.23 | 10.45 | 4664.87 | 919.18 |
| 2 | CG (NPB) | 1804 | 1367 | 14 | 31 | 31 | 8.71 | 0.59 | 12.27 | 4.06 | 5165.92 | 1018.35 |
| 3 | EP (NPB) | 1400 | 843 | 2 | 4 | 4 | 0.15 | 0.02 | 2.18 | 2.02 | 37.20 | 33.23 |
| 4 | FT (NPB) | 2223 | 1895 | 7 | 14 | 14 | 19.06 | 0.82 | 23.93 | 5.25 | 4820.49 | 745.79 |
| 5 | LU (NPB) | 4282 | 4138 | 8 | 35 | 185 | 55.57 | 0.85 | 68.68 | 9.84 | 4659.30 | 524.03 |
| 6 | MG (NPB) | 2068 | 2496 | 10 | 19 | 19 | 122.71 | 5.91 | 133.69 | 12.86 | 4846.00 | 4485.05 |
| 7 | SP (NPB) | 3463 | 4389 | 7 | 72 | 278 | 59.97 | 1.01 | 73.45 | 8.86 | 4167.48 | 572.87 |
| 8 | Quake | 2775 | 3068 | 11 | 22 | 30 | 31.61 | 0.41 | 36.34 | 5.04 | 4789.27 | 350.05 |
| | (SPEC) | | | | | | | | | | | |
| 9 | Amgmk | 1463 | 1804 | 2 | 5 | 5 | 97.82 | 4.57 | 107.92 | 11.51 | 5018.19 | 4537.33 |
| | (Sequoia) | | | | | | | | | | | |
| 10 | Clomp | 1148 | 3638 | 28 | 73 | 22268 | 798.45 | 94.83 | 857.86 | 128.98 | 4878.46 | 4979.51 |
| | (Sequoia) | | | | | | | | | | | |
| 11 | Stream | 214 | 727 | 10 | 20 | 12 | 2.98 | 0.17 | 4.78 | 2.41 | 1875.64 | 968.34 |
| | (Sequoia) | | | | | | | | | | | |
| 12 | Histo | 725 | 1914 | 1 | 2 | 2 | 2.17 | 0.28 | 4.88 | 2.91 | 231.98 | 105.76 |
| | (Parboil) | | | | | | | | | | | |
| 13 | Stencil | 641 | 1418 | 1 | 2 | 2 | 3.96 | 0.57 | 6.7 | 3.18 | 878.36 | 175.91 |
| | (Parboil) | | | | | | | | | | | |
| 14 | Tpacf | 774 | 1795 | 1 | 2 | 2 | 10.28 | 0.83 | 13.81 | 4.08 | 4183.77 | 213.64 |
| | (Parboil) | | | | | | | | | | | |

Abbreviations: #LOC = number of lines of code, #Leaf = number of leaf nodes in the super-graph (abstraction), #PC = number of static parallel constructs, #Barr = number of static barriers (implicit + explicit), and #Ph = number of static phases. STB-Time and Total-time refer to the stabilization time and total time, respectively, taken by the compiler to compile the benchmark (using EGINV and LZUPD modes). Memory refers to the maximum additional memory footprint for running BarrElem (with EGINV and LZUPD modes of stabilization). Data entries with the maximum savings in time and memory are shown in bold.

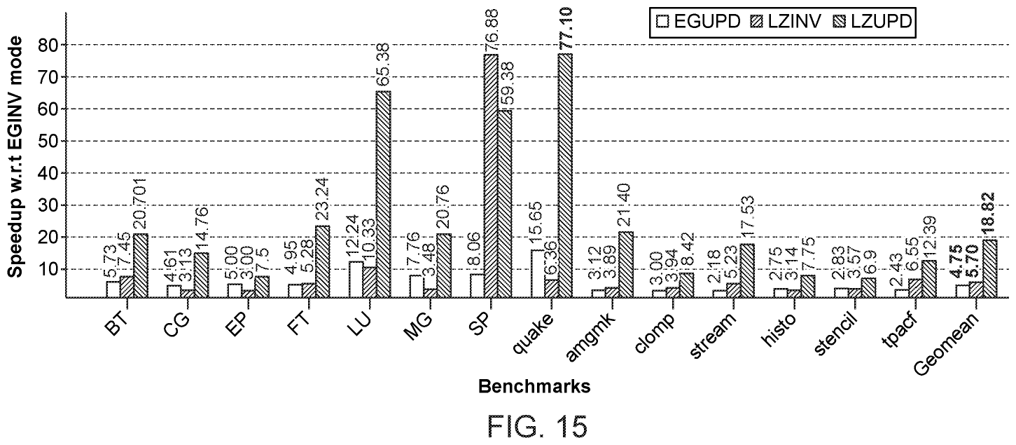

The impact of EGUPD, LZINV, and LZUPD, is illustrated by showing their relative speedups with respect to EGINV, in terms of speedups in IDFA stabilization-time (see FIG. 15); the raw numbers of stabilization-time for EGINV and LZUPD are shown in Table 1 (columns 7 and 8) for reference. As expected, the LZUPD mode incurs the least cost for stabilization among all the cases; consequently it results in the maximum speedup with respect to EGINV—with speedups varying between 6.9× to 77.1× (geomean=18.82×) in the time taken for stabilization of data-flow analysis. The gains using a particular mode of stabilization depend on multiple stabilization-mode specific factors, such as (i) number of triggers of stabilization, (ii) number of times the program nodes are re-processed during stabilization, (iii) cost incurred to process each program node, per stabilization, and so on.

LZUPD vs. EGINV: In case of speedups in the IDFA stabilization-time (FIG. 15), the gains observed due to LZUPD varied between 6.9× and 77.1×, across all the benchmarks. As explained above the actual gains depend on multiple factors. For example, the maximum speedup in the IDFA stabilization-time (77.1×) was observed for quake, consequent upon the fact that in quake, compared to EGINV, LZUPD re-processes only a small fraction (0.03%, data not shown) of the nodes. Similarly, the relatively lower speedups (even though still quite significant) observed in the LZUPD mode for stencil (6.9×), EP (7.5×), and histo (7.75×) can be attributed to the fact that in all these three benchmarks the number of nodes re-processed in the EGINV mode per invalidation was the least (data not shown) among the benchmarks under consideration.

LZUPD vs. EGUPD: It is clear from FIG. 15, that though EGUPD mode consistently performs better than EGINV, compared to LZUPD it performs significantly worse. This is because EGUPD processes significantly higher number of nodes compared to LZUPD.

LZUPD vs. LZINV: As shown in FIG. 15, in the context of IDFA stabilization-time, for all cases except SP, LZUPD performs better than LZINV (geomean 3.30× better). SP presents an interesting case, which shows that if the number of nodes processed is very high, then it is beneficial to rerun the complete analysis, instead of performing the updates incrementally. However, the difference between the actual stabilization times is very small (<0.25 s).

LZINV vs. EGUPD: As expected the performance comparison between LZINV and EGUPD throws a hung verdict, owing to benefits and losses due to lazy vs. eager and update vs. invalidate operations that are split between the two modes. Overall, LZINV outperformed EGUPD by a narrow margin (geomean speedup=1.2×).

Overall, the LZUPD mode leads to maximum benefits for stabilization time, across all four modes of stabilization. This in turn leads to significant improvement in the total compilation time, with speedup (compared to EGINV) varying between 1.08× to 10.4× (geomean=4.09×), across all the benchmarks (see columns 9 and 10 in Table 1, for the raw numbers). It was also seen that in most of the benchmarks LZUPD not only reduces the cost of stabilization, but also the rest of the compilation time ((column 9-column 7) vs. (column 10-column 8)), which was caused by the latent benefits (in cache, garbage collection and so on) arising due to significant reduction in memory usage (see columns 11 and 12).

### Example 3B: Performance Evaluation in Terms of Memory Consumption

The performance evaluation of the proposed lazy modes of stabilization was conducted by studying the parameters related to memory consumption, in the context of the optimization discussed in Example 2.

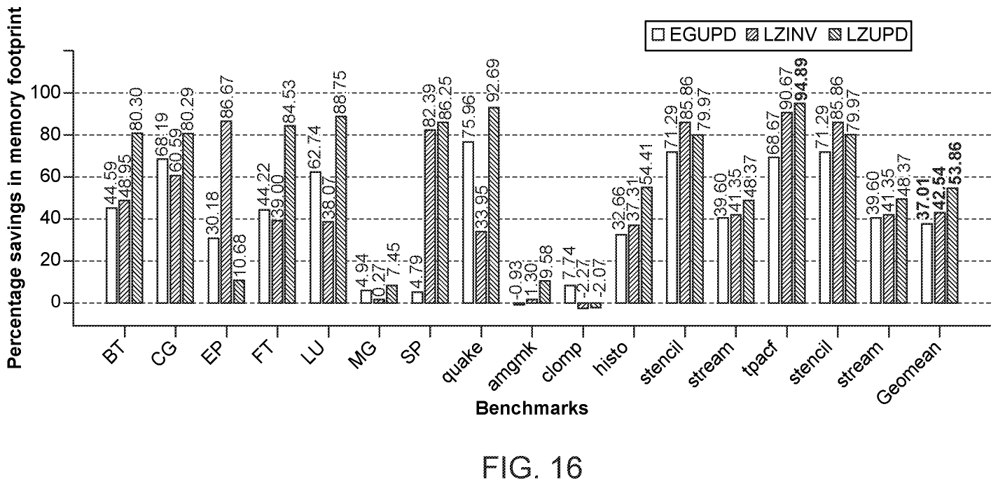

Table 1 (columns 11 and 12) shows the maximum additional memory footprint (in MB), in terms of the maximum resident size, while running barrier removal method from Example 2. The values were obtained by taking the difference of peak memory requirements during compilation with and without the optimization pass. The values shown were calculated with the help of /usr/bin/time GNU utility (version: 1.7). FIG. 16 illustrates the percentage savings in the memory footprint by EGUPD, LZINV, and LZUPD modes, as compared to the EGINV mode. All these three modes of stabilization perform better (or are more or less comparable), in terms of memory requirements, than the EGINV mode. The geomean improvements in memory consumption are 37.01%, 42.54%, and 53.86%, for EGUPD, LZINV, and LZUPD modes, respectively, as compared to the EGINV mode. As discussed above, both lazy and update options minimize the number of times different transfer functions are applied during stabilization of the data-flow analysis—this claim is substantiated by the observation that for most benchmarks (except EP, clomp, and stencil), LZUPD requires the least amount of memory, with maximum percentage savings of 94.89% for tpacf, over the EGINV mode.

The seeming discrepancy in EP and stencil is mostly an issue with the precision of measurement tool, where it is difficult to rely on the gains when the differences between the absolute values are small (in few tens of MB). Note that the tool is still effective in drawing a broad picture of the peak memory requirements. In clomp, the peak memory usage of LZUPD and LZINV are slightly higher (˜2%) than that of EGINV on analyzing the program using the java profiler jvisualvm, and this anomaly seems to be related to the behavior of the underlying GC, specifically on when the GC is invoked (impacts the peak memory-usage).

Overall, the proposed lazy modes of stabilization lead to significant memory savings compared to the naive EGINV scheme. This in turn can improve the memory traffic and overall gains in performance.

In order to empirically validate the correctness of the design/implementation of compiler and of points-to analysis, the points-to graphs for each benchmark under each mode of stabilization were verified. The state of final points-to graphs across all the four modes matched verbatim. For each benchmark, it was verified that the generated optimized code (i) does not differ across the four modes of self-stabilization, and (ii) produces the same output as that of the un-optimized code.

### Example 4: Self-Stabilization vs. Manual Stabilization

An empirical study for assessing the impact of the disclosed self-stabilizing compilation methods on writing different compiler passes, by comparing the coding efforts required to perform self-stabilization against manual stabilization, was performed. The study was performed in the context of various components of barrier removal optimization from Example 2.

A simple scheme to estimate the additional coding efforts that may be required to perform manual stabilization was used. The self-stabilizing compiler was profiled by instrumenting the implementations of barrier removal, as well as various program-abstractions, and the elementary transformations. By running this profiled compiler on each benchmark program, the following were obtained: (i) the set of change-points (or program points where an elementary transformation may happen) for barrier removal, and (ii) the set of program-abstractions that may be impacted by barrier removal. This data was used to estimate the manual coding efforts that may be required to overcome the problems when new abstractions and new optimizations were added.

### Example 4A: Where to Invoke Stabilization?

In Table 2, the number of change-points discovered in the major components of barrier removal is enumerated.

TABLE 2
Maximum number of change-points obtained within the components of
barrier removal upon running it on the benchmarks under study

| Component of BarrElem | LOC | #CP |
|---|---|---|
| Parallel-construct expansion | 1675 | 72 |
| Function inlining | 463 | 15 |
| Redundant-barrier deletion | 313 | 2 |
| Driver | 10 | 1 |
| Total | 2461 | 90 |

Abbr.: LOC = number of lines of code; #CP = number of change-points

In the absence of the disclosed method, the compiler writer would have to correctly identify these 90 change-points (i.e., on an average, almost 1 for every 28 lines of code) in barrier removal, and insert code for ensuring stabilization of the affected program abstractions. At each change-point, the compiler writer needs to handle stabilization of the impacted program-abstractions, irrespective of the chosen mode of stabilization. Ideally a program-abstraction A needs to be stabilized in response to the transformation at a change-point c1, if c1 is relevant for A. c1 is considered to be a relevant change-point for A, if A is read after the transformation performed at c1, and no other change-point is encountered in between. Thus the set of relevant change-points was used as a tighter approximation for the set of change-points after which A may have to be stabilized.

Table 3 lists the number of relevant change-points for each program-abstraction impacted by barrier removal; this data also was obtained from profiling the self-stabilizing compiler (profiling details discussed above).

TABLE 3
Program-Abstractions Read by Barrier Removal

| Program abstraction | Mode | \|STB\| | #A-CP |
|---|---|---|---|
| Points-to analysis | LZUPD | 316 | 12 |
| Control-flow graphs | LZUPD | 619 | 57 |
| Call graphs | LZUPD | 18 | 49 |
| Phase analysis | EGINV | 136 | 40 |
| Inter-task edges | EGINV | 70 | 15 |
| Symbol-/type-tables | LZUPD | 78 | 32 |
| Label-lookup tables | LZUPD | 477 | 32 |

Abbr: Mode = stabilization-mode; |STB| = LOC of stabilization-code; #A-CP = number of relevant change-points in the context of barrier removal after which the abstraction was read from.

Table 3 shows that there are significant number of places where this stabilization code needs to be invoked, in the absence of the disclosed method. For example, CFG stabilization needs to be performed at 57 places, and call-graphs at 49 places—which can lead to cumbersome and error-prone code. Further, upon addition of any new program-abstraction to the compiler, the compiler writer would have to revisit all the change-points of pre-existing optimizations (for example, 90 change-points for barrier removal) to check if the change-point may have necessitated stabilization of the newly added program-abstraction. In contrast, in the presence of the disclosed method, all the above tasks were automated—the compiler writer needed to spend no effort in identifying the places of stabilization, as the writer needs to add no additional code as part of the optimization in order to stabilize the program-abstractions.

### Example 4B: What to Stabilize?

On manually analyzing the code of barrier removal it was found that there are seven program-abstractions that were used and/or impacted by barrier removal. These are listed in Table 3. The non-zero numbers in column 4 show that the compiler writer indeed needs to invoke stabilization code for each of the seven program-abstractions during the execution of barrier removal. Thus, in case of manual-stabilization, on writing barrier removal, the compiler writer needs to identify these seven program-abstractions, from the plethora of available program-abstractions—a daunting task. Further, while adding any new program-abstraction A, the compiler writer needs to manually reanalyze barrier removal to check its impact on A. In contrast, in the presence of the disclosed method, these tasks are automated—the compiler writer needs to put no effort to identify the program-abstractions (existing or new) that may be impacted by an optimization pass.

### Example 4C: How to Stabilize?

For manual stabilization of a program-abstraction, the compiler writer chooses from any of the four modes of stabilization, or a combination thereof, as discussed earlier. Out of the seven program-abstractions that require stabilization by barrier removal, phase analysis and inter-task edges have been derived from YConAn, a concurrency analysis provided by Zhang and Dusterwald [2007, 2008]. It was not clear if a straightforward approach exists to support update modes of stabilization for YConAn. By inspecting the code of self-stabilizing compiler the amount of manual code required for stabilization of all the seven program-abstractions was estimated, as shown in Table 3. Upon adding a new program-abstraction, the compiler writer would need to write additional code manually for its stabilization. In contrast, in the context of the disclosed method, for the case of iterative data-flow analyses, such as points-to analysis (with 316 lines of code for manual stabilization) or any new IDFA-based program-abstraction, the compiler writer would not have to write any stabilization code. Therefore, in contrast to the traditional compilers, it was much easier to write optimizations or IDFA based analysis in the disclosed method, as the compiler writer does not have to worry about stabilization.

The disclosed method provides an optimization method to render various existing program-abstractions consistent with the modified program. The evaluation also shows that the disclosed method makes it easy to write optimizations and program analysis passes (with minimal code required to perform stabilization). Also, the lazy-update and lazy-invalidate stabilization choices lead to efficient compilers. The disclosed method provides guaranteed self-stabilization not just for the existing optimizations or program abstractions, but also for all the future optimizations or program-abstractions. The method provides explicit steps to ensure that the program-abstractions always reflect the correct state of the program at the time of being accessed, which in turn ensures the correctness of the inspection phases of the downstream optimizations, and hence the correctness of the generated output program.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here.

1. A computer-implemented method for automatic self-stabilizing compilation of programs, the method comprising:
receiving, by a processor, an input program;
generating, by the processor, a plurality of abstractions of the input program using a plurality of analysis operations, wherein each one of the plurality of abstractions represents information associated with a program state at compile time;
performing, by the processor, one or more optimization operations on one of the plurality of abstractions by modifying the program state associated with the abstraction based on a set of predetermined elementary transformations, wherein the set of predetermined elementary transformations capture the information associated with the modified program state; and
stabilizing by a stabilizer, one or more of the plurality of abstractions using the information captured by the set of predetermined elementary transformations in a stabilization mode, wherein the stabilizing comprises updating the one or more abstractions using the captured information to maintain consistency of the abstractions with the modified program states.

2. The method as claimed in claim 1, wherein the predetermined elementary transformations comprise adding, deleting, or modifying syntactic parts of the program.

3. The method as claimed in claim 1, wherein the stabilization mode is one of a lazy-invalidate stabilization mode, lazy-update stabilization mode, eager-update stabilization mode, eager-invalidate stabilization mode, or any combination thereof.

4. The method as claimed in claim 1, wherein the one or more abstractions represent information associated with a serial or a parallel program.

5. The method as claimed in claim 1, wherein the plurality of abstractions comprise intermediate representation, a control flow graph, and an abstract syntax tree.

6. The method as claimed in claim 1, comprising stabilizing the one or more abstractions in response to performing new optimization operation, wherein the stabilizing comprises updating the one or more abstractions to maintain consistency of the abstractions with the modified program states.

7. The method as claimed in claim 1, wherein the plurality of abstraction comprises iterative data flow analyses, and wherein the iterative data flow analyses is stabilized using automatic lazy-update stabilization mode.

8. A system for performing automatic self-stabilizing compilation of programs, the system comprising:
an analysis component configured to receive an input program and perform a plurality of analysis operations of the input program to generate a plurality of abstractions, wherein each one of the plurality of abstractions represents information associated with a program state at compile time;
an optimization component configured to perform one or more optimization operations on one of the plurality of abstractions by modifying the program state associated with the abstraction based on a set of predetermined elementary transformations, wherein the set of predetermined elementary transformations capture the information associated with the modified program state; and
a stabilizer configured to stabilize one or more of the plurality of abstractions using the information captured by the set of predetermined elementary transformations, wherein the stabilizing comprises updating the one or more abstractions using the captured information to maintain consistency of the abstractions with the modified program states.

9. The system as claimed in claim 8, wherein the analysis component comprises pre-processing unit, lexical analysis unit, syntax analysis unit, and semantic analysis unit.

10. The system as claimed in claim 8, wherein the stabilizer is configured to operate in a stabilization mode, wherein the stabilization mode is one of lazy-invalidate stabilization mode, lazy-update stabilization mode, eager-update stabilization mode, eager-invalidate stabilization mode, or any combination thereof.

11. The system as claimed in claim 8, wherein the optimization component comprises one or more abstraction readers and one or more abstraction writers, and wherein the one or more abstraction readers are configured to read the one or more abstractions and the one or more abstraction writers are configured to modify the one or more abstractions.
